(19) United States
(12) Patent Application Publication
(10) Pub. No.: US 2007/0182106 A1
(43) Pub. Date: Aug. 9, 2007

(54) Lubeless pipe gasket and method of fabrication

(76) Inventors: Jeffrey J. Biesenberger, Columbus, OH (US); Kevin S. Kish, Dublin, OH (US)

Correspondence Address: Patrick P. Phillips;Kremblas, Foster, Phillips & Pollick, 7632 Slate Ridge Blvd, Reynoldsburg, OH, 43068, US

(21) Appl. No.: 11/347,098

(22) Filed: Feb. 6, 2006

(51) Int. Cl. F16L 5/02

(52) U.S. Cl. 277/607

(57) ABSTRACT

A thermoplastic pipe gasket fabricated of a thermoset material is provided having a first pipe engaging surface and an exterior surface, with the exterior surface having applied thereto a water-based, flexible, slip-coating. The slip-coating comprises polyurethane, a cross-linking agent, and a dispersion of a friction reducing compound. The friction reducing compound can be selected from a fluoropolymer, silicone, or graphite, either alone or in combinations thereof. Depending on the method of fabrication, the slip-coating can be sprayed onto the thermoset material after the thermoset material has been extruded, but before the extrudate's fabrication into a gasket. Alternatively, the slip-coating can be sprayed onto the gasket following its assembly. Still further, the slip-coating can be applied to the thermoset material by dipping the thermoset material into the water-based, flexible, slip-coating.

### BACKGROUND OF THE INVENTION

1. Field of the Invention

This invention relates generally to pipe gaskets, and more particularly, to such gaskets that are used with plastic pipe, and even more particularly to a thermoplastic pipe gasket having a flexible slip-coating, and its method of manufacture.

2. Description of the Related Art

This invention is directed to a method for fabricating, and the providing of, a gasket for use with pipe. Preferably the type of pipe is plastic. More preferably the type of pipe is corrugated pipe, however the invention could be used on other pipe.

Gaskets for pipe are well known in the art. In some cases, when two pipe sections are to be joined together, a coupling and a coupling gasket are used, as disclosed in Schultz, U.S. Pat. No. 6,371,491. In other applications, the pipe sections feature a bell and spigot design, wherein one of the pipe end sections has an enlarged bell portion and the other pipe end section (referred to as the spigot) is inserted into the bell, with a gasket in contacting relationship intermediate each of the pipe end sections so as to form a seal between the pipe sections.

Typically, a large frictional force is encountered when the inner pipe and the gasket is inserted into the bell. As the spigot is pushed into the bell of the outer pipe section, it is thus possible for the gasket to be forced from its desired position. For example, when installed in its operative position on an end of corrugated pipe, a gasket is typically located in one of the valleys associated with a corrugation. However, if the gasket is pushed out of its desired position, it may be pushed beyond the valley where it was designed to be located. The unwanted displacement of the gasket may preclude proper sealing, and may also contribute to leakage.

To obviate unwanted gasket displacement, the prior art of pipe coupling has utilized manually applied lubricant to reduce the frictional force between the gasket and the outer pipe. The reduced frictional force lessens the likelihood that the gasket will be displaced. However, the manual application of lubricant is labor intensive, messy, and potentially requires reapplication of the lubricant if the pipe sections are disassembled for some reason. Often, the lubricant is in the form of what is called “tub lube”, a lubricant containing animal fat that is typically rubbed on by hand to the inside of the bell as well as onto the outside of the gasket. This lubricant often is supplied in a tub (hence its name) which is transported to the specific location where the pipe sections are being coupled.

Consequently, it has been desirable to develop alternatives. While lessening the actual amount of tub lube used based on a better appreciation of how much is realistically needed is an improvement, one approach to the problem has concentrated on completely eliminating the use of tub lube by temporarily encasing a lubricant within the gasket. For example, in accordance with this approach gaskets have been developed which contain a covered slit or abcess wherein lubricant is enclosed, such that when two pipe sections are slid together, the lubricant is released and migrates onto the exterior surface of the gasket. Examples of this type of approach are disclosed in Miller, U.S. Pat. No. 3,058,752, Sporre, U.S. Pat. No. 4,410,185, and Sutherland et al, U.S. Pat. No. 5,626,349. However, such methods provide the lubricant only the first time, or a limited number of times, the gasket forms a seal. The lubricant is eventually wiped off or spent. Once the lubricant is wiped off or spent, a lubricant may need to be manually applied to ensure a proper seal.

Another more recent approach to the problem has been an attempt at providing a permanently lubricated gasket, such as is disclosed in Beach et al, U.S. Ser. No. 2004/0041347. Under this approach a gasket is extruded featuring an elastomeric thermoplastic material containing a silicone dispersion. There also is an extruded permanently lubricated gasket formed of a thermoplastic vulcanizate (TPV)(i.e. a thermoplastic comprising a blend of rubber and polypropylene).

Even with the evolution of gaskets, problems with messiness, ease and time of assembly, and overall cost still remain. It is thus apparent that the need exists for a pipe gasket which addresses the foregoing needs.

### SUMMARY OF THE INVENTION

In accordance with the present invention, there is disclosed a thermoplastic pipe gasket fabricated of a thermoset material, with the gasket having a first pipe engaging surface and a second pipe engaging surface located on oppositely facing surfaces of the gasket, one outwardly (i.e. away from the gasket) and the other inwardly (i.e. towards the center of the gasket), with the second pipe engaging surface having an exterior surface having applied thereto a flexible, slip-coating with a friction reducing compound.

The slip-coating comprises polyurethane and a dispersion of a friction reducing compound. The slip-coating preferably also includes a bonding promoter and a cross-linking agent. The friction reducing compound is preferably selected from a group comprising fluoropolymers, silicone, or graphite, either alone or in combinations thereof. The fluoropolymer selected can be polytetrafluoroethylene. Additionally, the thermoset material can be synthetic rubber, including EPDM, nitrile, neoprene, or combinations thereof, or natural rubber, including polyisoprene. The slip-coating can be water-based or solvent-based.

Depending on the method of fabrication, the slip-coating can be applied to the thermoset material after the thermoset material has been extruded during the fabrication of the gasket, but before the extruded material has been joined together to form the gasket. Alternatively, the slip-coating can be applied to the gasket following its assembly. Still further, the slip-coating can be applied to the thermoset material by spraying, brushing, wiping, or dipping. In one embodiment, the flexible, slip-coating is applied in a plurality of steps, with different steps including different components of the slip-coating.

There is also disclosed a thermoplastic pipe gasket formed by the process having the following steps: (a) having hot thermoset material flow through a die head to form an elongate body having a predetermined cross-section, with the elongate body having an exterior surface; (b) applying a flexible, slip-coating to the exterior surface of the thermoset material, with the slip-coating having therein a friction reducing compound; (c) curing the slip-coating; (d) cutting the thermoset material; and (e) splicing the elongate body to form a gasket having a first pipe engaging surface and an exterior surface. In another embodiment of the process, the gasket is formed using a process which includes the additional step of curing the hot thermoset material after it is extruded, but before the flexible, slip-coating is applied thereto.

There is also disclosed a thermoplastic pipe gasket formed by the process having the following steps: (a) having hot thermoset material flow through a die head to form an elongate body having a predetermined cross-section, with the elongate body having an exterior surface; (b) cutting the thermoset material; (c) applying a flexible, slip-coating to the exterior surface of the thermoset material, with the slip-coating having therein a friction reducing compound; (d) curing the slip-coating; and (e) splicing the cut thermoset material to form a gasket having a first pipe engaging surface and an exterior surface. In another embodiment of the process, the gasket is formed using a process having the following steps: (a) having hot thermoset material flow through a die head to form an elongate body having a predetermined cross-section, with the elongate body having an exterior surface; (b) curing the thermoset material; (c) cutting the thermoset material; (d) splicing the thermoset material to form a gasket having a first pipe engaging surface and an exterior surface; (e) applying a flexible, slip-coating to the exterior surface, with the slip-coating having therein a friction reducing compound; and (f) curing the slip-coating.

The primary objective of this invention is to provide a Tubeless pipe gasket that does not require the application of a lubricant to its surface in the field in order to facilitate the joining together of adjacent sections of plastic pipe.

Another objective of this invention is to provide such a gasket which is relatively easy to fabricate.

Still another objective of this invention is to provide a gasket that addresses environmental concerns, such as VOC issues.

Other objects and advantages of the invention will be apparent from the following description, the accompanying drawings and the appended claims.

### BRIEF DESCRIPTION OF THE DRAWINGS

FIG. 1 is a partial perspective view of a gasket made in accordance with the present invention.

In describing the preferred embodiment of the invention which is illustrated in the drawing, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

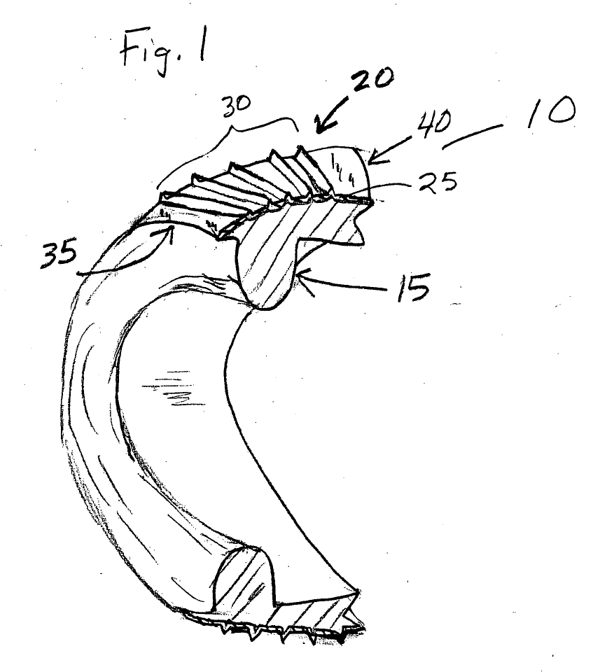

Having reference to the drawing, attention is directed to FIG. 1, which discloses a gasket for pipe made in accordance with the invention designated generally by the numeral 10. It should be appreciated that the overall cross-sectional shape of the gasket or its diameter is not critical, rather the invention concerns the fact that the gasket is Tubeless, and as such can be utilized with a plurality of gasket shapes and sizes.

A gasket made in accordance with this invention can be fabricated from a variety of materials known in the manufacture of gaskets, such as synthetic or natural rubber, with the types of natural rubber including polyisoprene, and with the types of synthetic rubber including Ethylene Propylene Diene Monomer (or Terpolymer, which is simply a product consisting of three distinct monomers) (EPDM), nitrile, and neoprene, or a combination thereof. It should also be appreciated that in stating that the invention is a thermoplastic pipe gasket it should be understood that it is a gasket for thermoplastic pipe, not a thermoplastic gasket per se. Instead, the gasket of this invention is fabricated from a thermoset material.

Having reference to the drawing figure, the gasket has a first pipe engaging surface 15 which will typically be found on the inwardly facing wall of the gasket. This surface of the gasket is the one which would be in contact with the exterior surface of the spigot portion of a pipe in a bell and spigot connection of the type well known in the art.

Meanwhile, the gasket 10 also has a second pipe engaging surface 20, which will typically be found on the exterior of the gasket, however, contrary to the prior art, the second pipe engaging surface 20 of the gasket 10 of this invention has applied thereto a flexible, slip-coating 25. The slip-coating 25 comprises polyurethane, and a friction reducing compound, with the friction reducing compound preferably being in the form of a dispersion. The slip-coating also preferably includes a cross-linking agent to hasten or facilitate the setting up of the polyurethane, and a bonding promoter to provide better bonding at the interface of the thermoset material and the slip-coating. This slip-coating has in the range of 15-60% solids content by weight, with the preferable amount of solids content by weight being in the range of 30-45%, and the most preferable amount being about 37%.

The adhesion or bonding promoter facilitates a better bond between the slip-coating and the exterior rubber surface 20 of the gasket 10. The cross-linking agent, preferably a liquid, helps set up the urethane in the slip-coating.

The friction reducing compound can be selected from a group of compounds that includes fluoropolymers, silicone, and graphite, either alone or in combinations thereof. In the preferred embodiment of the invention a fluoropolymer is utilized by itself as the friction reducing compound. The fluoropolymer selected for the preferred embodiment is polytetrafluoroethylene (PTFE), with one brand of PTFE marketed under the TEFLON trademark.

One commercially available product that can be used as the slip-coating is EMRALON TW-020, a water-based, flexible, fluoropolymer coating sold by Acheson Colloids Co. of Port Huron, Mich. The two-component, water-based, resin-bonded, fluropolymer coating has a polyurethane binder, a cross-linking agent, and PTFE.

Turning now to the method of fabrication, there are several options which can be utilized to result in the gasket of this invention. In all of the options, the hot thermoset material flows through a die head to form an elongate body having a predetermined length and cross-section. Then for example in the first option, the slip-coating 25 is sprayed onto the thermoset material, after the thermoset material has been extruded during the fabrication of the gasket, but before the extruded material has been joined together to form the gasket. Once the slip-coating is applied to the extrudate, curing occurs in a manner well known in the art. Once curing occurs, the extrusion is cut and then spliced to form the continuous ring of the gasket 10. In stating that the extrudate is “hot”, it should be appreciated that the temperature of the extrudate as it exits the diehead is approximately 80° C.

Alternatively, the slip-coating 25 can be sprayed onto the gasket 10 following its assembly into a ring. This spraying would preferably occur in the plant where the gasket is assembled, with any such spraying on of the slip-coating utilizing spraying equipment and methodology well known in the art. Thereafter, curing of the slip-coating occurs in a manner well known in the art.

Still further, the slip-coating can be applied to the thermoset material by dipping the thermoset material, once it has been extruded, into the water-based, flexible, slip-coating. For example, the extrudate could be extruded with the second pipe engaging surface facing downwardly, unlike the preferred orientation associated with the extrudate when spraying is done at the time of extrusion wherein the second pipe engaging surface is typically facing upwardly. In this embodiment of a process, the extrudate could be made to pass through a bath of the slip-coating, thus providing for its application to what will ultimately become the exterior surface of the gasket.

Regardless of the method of fabrication, it should also be recognized that the spraying or dipping can cover all or only a predetermined portion of the second pipe engaging surface. That is because depending on the shape of the gasket and the area of actual contact between the gasket and the second pipe, the slip-coating may not necessarily have to completely cover the gasket in order to provide for the relatively easy engagement of and sealing between the two pipes in contacting relationship with the gasket when sealing occurs. Thus, the slip-coating may only extend part way across the width of the gasket in FIG. 1 as shown by way of example by the numeral 30, or it could be applied so as to extend completely across the gasket from first edge 35 to second edge 40, or it could be applied so as to intermittently extend part way across the width of the gasket.

The gasket of this invention does not need tub lube applied to it in order for it to work in field installations. It also does not have powder easily dislodged from its surface whether in storage, shipping, or installation.

The gasket of this invention provides a fluid-tight seal between connected pipes. Additionally, the slip-coating that is formed has been found to be durable and weatherable.

Additionally, there are low VOC issues associated with this gasket and its process of fabrication, due to the water-based components in the slip-coating. By obviating most VOC issues, the method of fabrication of the gasket of this invention proactively addresses potential environmental concerns.

While the form of apparatus herein described constitutes a preferred embodiment of the present invention, it is to be understood that the invention is not limited to this precise form of apparatus and that changes may be made therein without departing from the scope of the invention which is defined in the appended claims.

What is claimed is:

1. A thermoplastic pipe gasket, said gasket fabricated of a thermoset material, said gasket comprising a first pipe engaging surface and an exterior surface, said exterior surface having applied thereto a flexible, slip-coating, said slip-coating comprising a friction reducing compound.

2. The gasket according to claim 1 wherein said slip-coating comprises polyurethane, a cross-linking agent, and a dispersion of a friction reducing compound.

3. The gasket according to claim 1 wherein said slip-coating comprises polyurethane, a bonding promoter, and a dispersion of a friction reducing compound.

4. The gasket according to claim 1 wherein said friction reducing compound is selected from the group comprising fluoropolymers, silicone, and graphite.

5. The gasket according to claim 4 wherein said fluoropolymer is polytetrafluoroethylene.

6. The gasket according to claim 1 wherein said slip-coating is water-based.

7. The gasket according to claim 1 wherein said slip-coating is solvent-based.

8. The gasket according to claim 1 wherein said flexible, slip-coating is applied to the thermoset material after said thermoset material has been extruded during the fabrication of said gasket.

9. The gasket according to claim 1 wherein said flexible, slip-coating is applied to said gasket in a manner selected from the group comprising spraying, brushing, wiping or dipping.

10. The gasket according to claim 1 wherein said flexible, slip-coating is applied in a plurality of steps, with different steps including different components of said slip-coating.

11. The gasket according to claim 1 wherein said thermoset material is selected from the group comprising synthetic rubber and natural rubber.

12. A thermoplastic pipe gasket formed by the process comprising the steps of:
(a) having hot thermoset material flow through a die head to form an elongate body having a predetermined cross-section, said elongate body having an exterior surface;
(b) applying a flexible, slip-coating to said exterior surface, said slip-coating comprising a friction reducing compound;
(c) curing said slip-coating;
(d) cutting said thermoset material; and
(e) splicing said elongate body to form a gasket having a first pipe engaging surface and an exterior surface.

13. The gasket formed by the process according to claim 12, which includes the additional step of curing the hot thermoset material after it is extruded, but before the flexible, slip-coating is applied thereto.

14. A thermoplastic pipe gasket formed by the process comprising the steps of:
(a) having hot thermoset material flow through a die head to form an elongate body having a predetermined cross-section, said elongate body having an exterior surface;
(b) cutting said thermoset material;
(c) applying a flexible, slip-coating to said exterior surface, said slip-coating comprising a friction reducing compound;
(d) curing said slip-coating and thermoset material; and
(e) splicing the cut thermoset material to form a gasket having a first pipe engaging surface and an exterior surface.

15. The thermoplastic pipe gasket formed by the process comprising the steps of:
(a) having hot thermoset material flow through a die head to form an elongate body having a predetermined cross-section, said elongate body having an exterior surface;
(b) curing said thermoset material;
(c) cutting said thermoset material;
(d) splicing said thermoset material to form a gasket having a first pipe engaging surface and an exterior surface;
(e) applying a flexible, slip-coating to said exterior surface, said slip-coating comprising a friction reducing compound; and
(f) curing said slip-coating.
